(19) United States
(12) Patent Application Publication
(10) Pub. No.: US 2006/0198770 A1
(43) Pub. Date: Sep. 7, 2006

(54) Ozone generator

(76) Inventor: Ching-Fu Lai, Taipei Hisen (TW)

Correspondence Address: Ching-Fu Lai, 235 Chung - Ho Box 8-24, Taipei, TW

(21) Appl. No.: 11/078,967

(22) Filed: Mar. 7, 2005

(51) Int. Cl. B01J 19/08

(52) U.S. Cl. 422/186.07

(57) ABSTRACT

An ozone generator comprises a machine box, a cover, a high-voltage supply, an electrode device and a control circuit board. The electrode device has a set of discharging electrodes with pointed members and a guiding electrode. The guiding electrode further comprises a contact plate mounted on the machine box for grounding and an electrode board retained within said cover. The electrode board is provided with a plurality of round holes corresponding to the pointed members of the discharging electrode, Thereby, electric energy will be transported from the high-voltage supply to the electrode device, then emitting into the ozone generating chamber through discharging. The air flowing into the ozone generating chamber will be activated to form ozone gas that will be released to the surroundings. Further, as the cover is removed from the machine box, the discharging will be terminated automatically, ensuring the operational safety of the ozone generator.

### FIELD OF THE INVENTION

The present invention relates to ozone generators, more particularly to an ozone generator having sterilizing and deodorizing functions wherein a cover can change the position of an electrode within the machine, so that the discharging mechanism stops to function as the cover is removed form the machine, therefore ensuring the operational safety of the ozone generator.

### BACKGROUND OF THE INVENTION

Because of its efficiency in the reduction of oxygen gas, ozone gas has the functions of sterilization, deodorization and detoxification and is therefore widely used in water processing, industries and households. The most common means to produce ozone gas are high-voltage discharging and photochemistry. The latter means utilizes an ultraviolet light tube to illuminate the air with a light of wavelength below 200 nm, as shown in FIG. 1. However, an ultraviolet light tube 10 has a fixed length and needs a starter 11 and an electronic ballast 12, and therefore a product with this means cannot be of compact volume and low production cost. Further, since the ultraviolet light tube 10 has a finite life span, replacing ultraviolet light tubes is an additional cost for the consumers, which is not cheap. On the other hand, the high-voltage discharging means utilizes a two-polarity electrode device having a potential difference of 4000-6000 volts across, which can directly activate the air and produce ozone gas. A product using this means can be compact and of low production cost. Further, this means does not consume ultraviolet light tubes.

However, the high-voltage discharging means has potential danger to a user due to its high operation voltage. Since the spacing between the oppositely polarized electrodes is small, the oxidized layers formed on the surfaces of the electrodes after using for a period of time will affect the efficiency of ozone production. Therefore, the electrodes have to be cleaned regularly, which is a potentially dangerous process to a user.

### SUMMARY OF THE INVENTION

Accordingly, the primary objective of the present invention is to provide an ozone generator comprising a machine box, a cover, a high-voltage supply, an electrode device and a control circuit board. The electrode device, installed within an ozone generating chamber of the machine box, has a set of discharging electrodes with pointed members and a guiding electrode. The guiding electrode further comprises a contact plate mounted on the machine box for grounding and an electrode board retained within said cover. The electrode board is provided with a plurality of round holes corresponding to the pointed members of the discharging electrode, whereby, as the cover is coupled with the machine box, the electrode board will be pushed downward and brought within a predetermined distance with the discharging electrodes. Thereby, electric energy will be transported from the high-voltage supply to the electrode device, then emitting into the ozone generating chamber through discharging. The air flowing into the ozone generating chamber will be activated to form ozone gas that will be released to the surroundings. Further, as the cover is removed from the machine box, the discharging will be terminated automatically, ensuring the operational safety of the ozone generator.

The secondary objective of the present invention is to provide an ozone generator of small volume, so that it can fit various spaces. The ozone generator further has a flexibility of adjusting the ozone production rate by adjusting the coupling between the discharging electrodes and the guiding electrode.

It is a further objective of the present invention that the cover of the ozone generator can be of various shapes and colors, depending on the decorative purposes of the consumers. The cover can be easily replaced, and therefore the life span of the product can be extended.

The various objects and advantages of the present invention will be more readily understood from the following detailed description when read in conjunction with the appended drawings.

### BRIEF DESCRIPTION OF THE DRAWINGS

FIG. 1 is an exploded perspective view of an ozone generator of the prior art.

FIG. 2 is a perspective view of an ozone generator according to the present invention.

FIG. 3 is an exploded perspective view of the ozone generator in FIG. 2.

FIG. 4 illustrates the installation of the ozone generator in FIG. 2.

FIG. 5 is a lateral cross-sectional view of the ozone generator in FIG. 2, illustrating the function of the ozone generator.

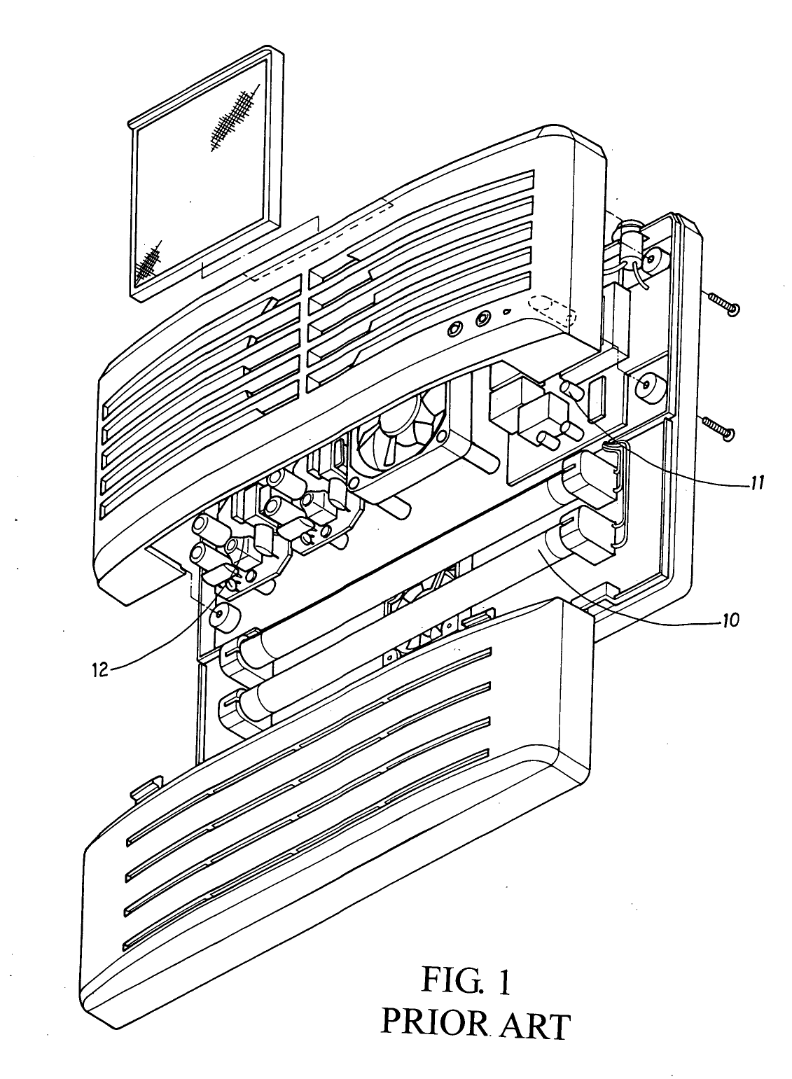

### DETAILED DESCRIPTION OF THE PREFERRED EMBODIMENTS

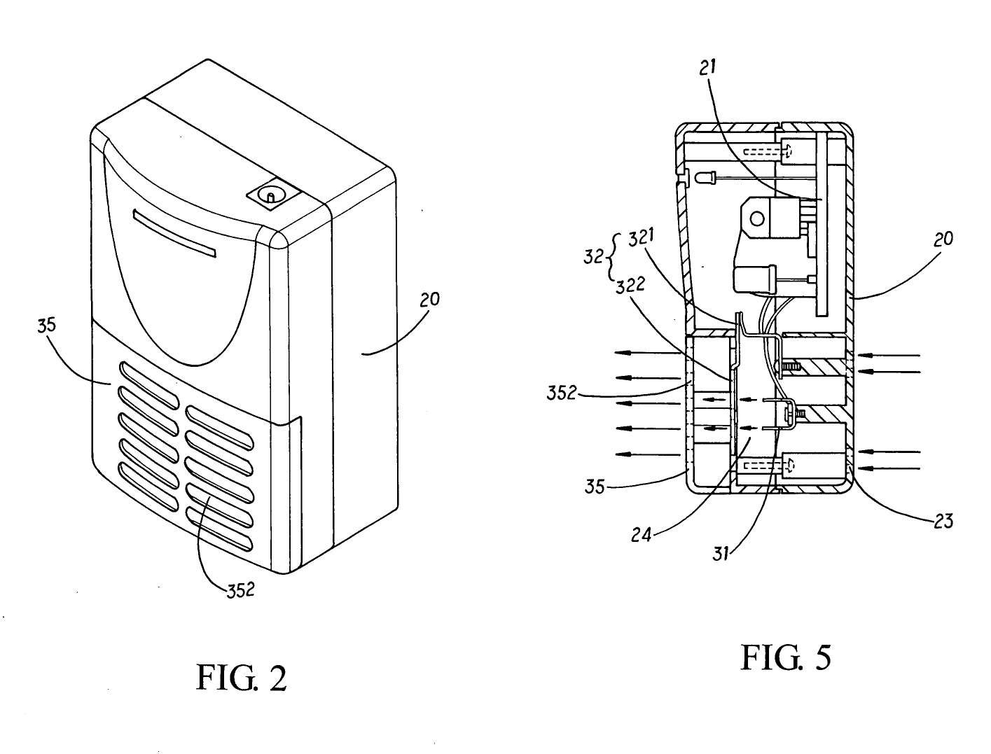

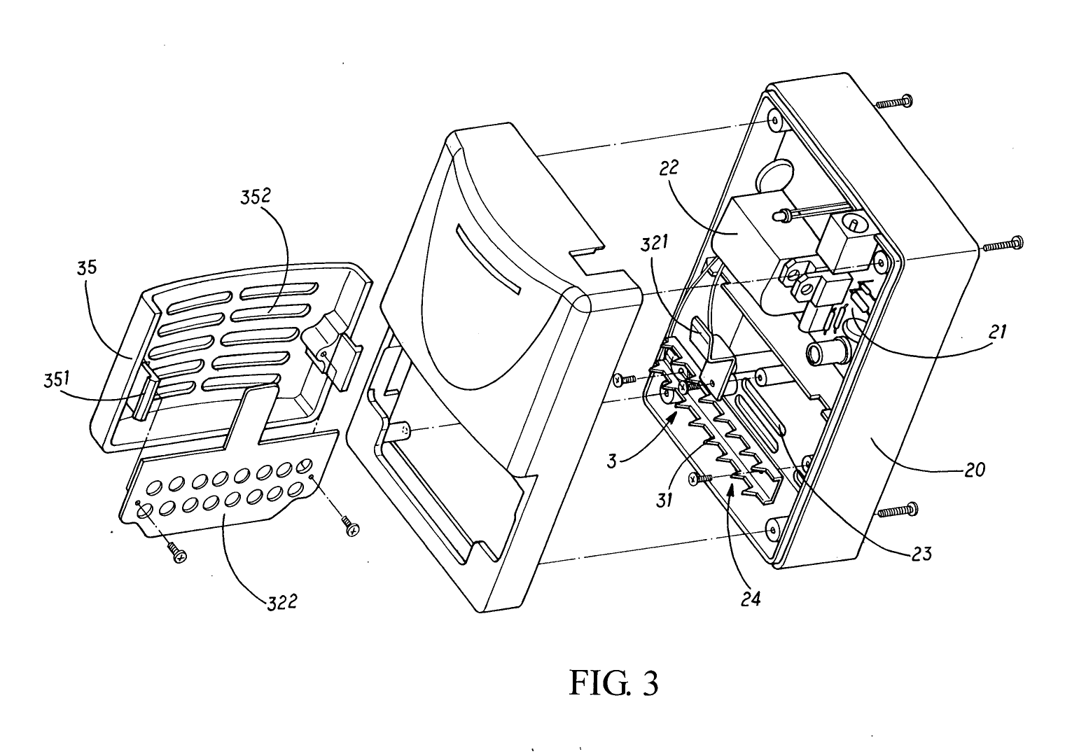

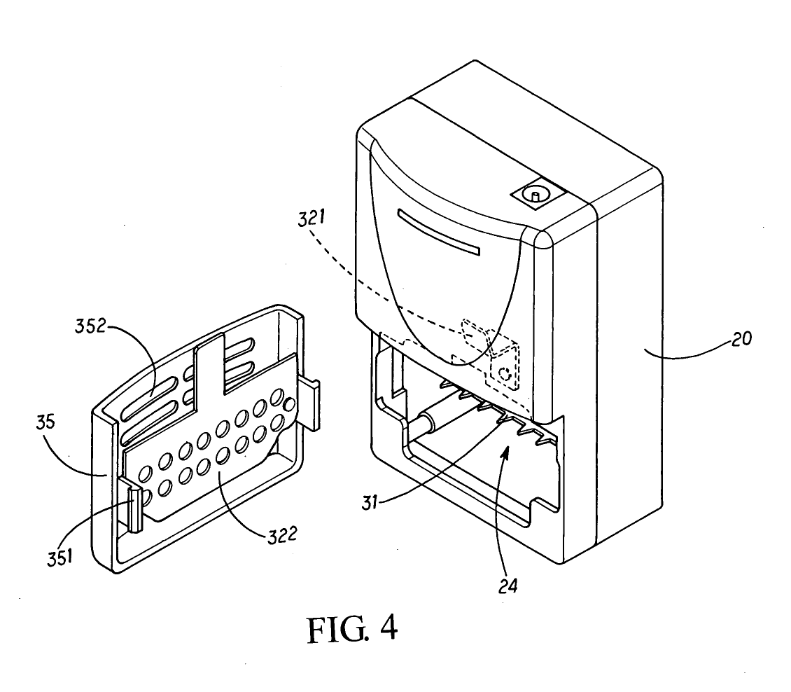

Referring to FIGS. 2 and 3, an ozone generator according to the present invention comprises a machine box 20, a control circuit board 21, a high-voltage supply 22 and an electrode device 3. The control circuit board 21 has a control unit, not shown in the figures, for controlling the production rate and the on/off of power. The machine box 20 is provided with a plurality of air inlets 23 and an ozone generating chamber 24 wherein the electrode device 3 situates. The ozone generating chamber 24 further includes a set of discharging electrodes 31 with pointed members, connected to the high-voltage supply 22 by wires, and a guiding electrodes 32 consisting of a flexible, metallic contact plate 321 mounted on the machine box 20 for grounding and an electrode board 322, which is separated from the machine box 20 and retained within a cover 35 for sealing an opening above the ozone generating chamber 24 on the machine box 20. After the cover 35 is engaged with the machine box 20, the contact plate 321 is brought to a position where a plurality of round holes is aligned with the pointed members of the discharging electrodes 31. The contact plate 321 is made of conducting material, whereas the cover 35 is insulating having a plurality of retaining ears 351 on the lateral sides of the cover 35 for being embedded into the inner wall of the machine box 20, whereby the machine box 20 is coupled with the cover 35 and the ozone generating chamber 24 is covered. After the cover 35 and the machine box 20 are engaged, the electrode board 322 is held at a predetermined spacing from the discharging electrodes 31, having one end thereof attached with the contact plate 321, as shown in FIG. 4.

According to the above configuration, electric energy is transported from the high-voltage supply 22 to the electrode device 3 and then emitted into the ozone generating chamber 24 through discharging, whereby the air flown from the air inlets 23 will be activated to form ozone gas, which will be emitted to the surroundings through the air vents 352 on the cover 35, as shown in FIG. 5. Further, the cover 35 can be removed form the machine box 20, so that the discharging electrodes 31 and the guiding electrodes 32 are away from each other, whereby the discharging will stop.

Further, a sensing switch, such as a micro switch or a photo-electric switch, can be disposed between the machine box 20 and the cover 35, such that, when the cover 35 is detached from the machine box 20, the sensing switch will be activated and send a signal to the control unit on the control circuit board 21, which in turn will terminate the discharging of the electrode device 3.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An ozone generator, comprising:
a machine box having a plurality of air inlets and an ozone generating chamber both located on an inner bottom side thereof,
a cover for sealing an opening above said ozone generating chamber on said machine box, said cover further including a plurality of air vents;
a high-voltage supply mounted on said machine box;
an electrode device installed within said ozone generating chamber having a set of discharging electrodes with pointed members and a guiding electrode, said discharging electrodes being connected to said high-voltage supply by a plurality of wires, said guiding electrode comprising a contact plate mounted on said machine box for grounding and an electrode board retained within said cover, said electrode board being provided with a plurality of round holes corresponding to said pointed members of said discharging electrodes, whereby, as said cover is coupled with said machine box, said electrode board will be pushed downward and close to said discharging electrodes and will maintain a predetermined spacing with said discharging electrodes; and
a control circuit board.

2. The ozone generator of claim 1 wherein said contact plate is a flexible made of metallic materials.

3. The ozone generator of claim 1 wherein said control circuit board has a control unit for controlling ozone production rate and power startup.

4. The ozone generator of claim 1 wherein said cover is mounted onto said machine box by a buckling means.

5. The ozone generator of claim 1 wherein at lease two opposite lateral sides of said cover are respectively provided with retaining ears for engaging with the inner rim of said opening of said machine box.

6. The ozone generator of claim 4 wherein at lease two opposite lateral sides of said cover are respectively provided with retaining ears for engaging with the inner rim of said opening of said machine box.

7. The ozone generator of claim 1 wherein a sensing switch is disposed between said cover and said machine box for sending a signal to said control unit of said control circuit board, thereby said control circuit board terminating the discharging of said discharging electrodes.

8. The ozone generator of claim 6 wherein said sensing switch is selected from the group of a micro switch and a photo-electric switch.
